(19) United States
(12) Patent Application Publication
(10) Pub. No.: US 2016/0229752 A1
(43) Pub. Date: Aug. 11, 2016

(54) METHODS FOR CHARACTERIZING A POLYCRYSTALLINE DIAMOND ELEMENT BY POROSIMETRY

(71) Applicant: US Synthetic Corporation, Orem, UT (US)

(72) Inventors: Kenneth E. Bertagnolli, Riverton, UT (US); Julie Ann Kidd, North Ogden, UT (US); Dwight Randall Hiebert, Butte, MT (US); Jay Walter McCloskey, Butte, MT (US); Robert John Hyatt, Butte, MT (US); Brian Thomas Park, Butte, MT (US)

(21) Appl. No.: 14/329,552

(22) Filed: Jul. 11, 2014

Related U.S. Application Data
(60) Provisional application No. 61/846,138, filed on Jul. 15, 2013.

(51) Int. Cl. C04B 35/52; C22C 26/00; C04B 35/622; G01N 15/08

(52) U.S. Cl. CPC C04B 35/52; G01N 15/0886; C22C 26/00; C04B 35/622; C04B 2235/3817; C04B 2235/616; C04B 2235/658; C04B 2235/656; C04B 2235/74

(57) ABSTRACT

Embodiments disclosed herein relate to methods for measuring at least one pore characteristic of a polycrystalline diamond (“PCD”) element via porosimetry and, for example, using the measurement to adjust one or more process parameters for fabricating a PCD element and/or for quality control on such a PCD element. In an embodiment, a method for characterizing a PCD element is disclosed. The method includes providing a PCD element that includes a plurality of bonded diamond grains defining a plurality of pores therebetween. The method further includes conducting porosimetry on the PCD element to measure at least one pore characteristic of the plurality of pores of the PCD element. In an embodiment, the method additionally includes adjusting the one or more process parameters for fabricating the PCD element at least partially based on the measured at least one pore characteristic.

### CROSS-REFERENCE TO RELATED APPLICATIONS

This application claims priority to U.S. Provisional Application No. 61/846,138 filed on 15 Jul. 2013, the disclosure of which is incorporated herein, in its entirety, by this reference.

### BACKGROUND

Wear-resistant, polycrystalline diamond compacts (“PDCs”) are utilized in a variety of mechanical applications. For example, PDCs are used in drilling tools (e.g., cutting elements, gage trimmers, etc.), machining equipment, bearing apparatuses, wire-drawing machinery, and in other mechanical apparatuses.

PDCs have found particular utility as superabrasive cutting elements in rotary drill bits, such as roller-cone drill bits and fixed-cutter drill bits. A PDC cutting element typically includes a superabrasive diamond layer commonly known as a diamond table. The diamond table is formed and bonded to a substrate using a high-pressure/high-temperature (“HPHT”) process under diamond-stable conditions. The PDC cutting element may be brazed directly into a preformed pocket, socket, or other receptacle formed in a bit body. The substrate may often be brazed or otherwise joined to an attachment member, such as a cylindrical backing. A rotary drill bit typically includes a number of PDC cutting elements affixed to the bit body. It is also known that a stud carrying the PDC may be used as a PDC cutting element when mounted to a bit body of a rotary drill bit by press-fitting, brazing, or otherwise securing the stud into a receptacle formed in the bit body.

Conventional PDCs are normally fabricated by placing a cemented carbide substrate into a container or cartridge with a volume of diamond particles positioned on a surface of the cemented-carbide substrate. A number of such cartridges may be loaded into an HPHT press. The substrate(s) and volume(s) of diamond particles are then processed under HPHT conditions in the presence of a catalyst material that causes the diamond particles to bond to one another to form a matrix of bonded diamond grains defining a polycrystalline diamond (“PCD”) table. The catalyst material is often a metal-solvent catalyst (e.g., cobalt, nickel, iron, or alloys thereof) that is used for promoting intergrowth of the diamond particles.

In one conventional approach, a constituent of the cemented carbide substrate, such as cobalt from a cobalt-cemented tungsten carbide substrate, liquefies and sweeps from a region adjacent to the volume of diamond particles into interstitial regions between the diamond particles during the HPHT process. The cobalt acts as a catalyst to promote intergrowth between the diamond particles, which results in formation of a matrix of bonded diamond grains having diamond-to-diamond bonding therebetween, with interstitial regions between the bonded diamond grains being occupied by the solvent catalyst. Accordingly, diamond grains become mutually bonded to form a matrix of PCD, with interstitial regions between the bonded diamond grains being occupied by the solvent catalyst.

### SUMMARY

Embodiments of the invention relate to methods for measuring at least one pore characteristic of a PCD element (e.g., a PCD table) via porosimetry and, for example, using the measurement to adjust one or more process parameters for fabricating a PCD element and/or for quality control on such a PCD element that are suitable for use in a subterranean drilling apparatus. Measurement of the at least one pore characteristic may be used to adjust process parameters for fabricating a PCD element to, for example, accurately control leaching processing, catalyst concentration therein, and extent of diamond-to-diamond bonding therethrough, or perform quality control on a PCD element.

In an embodiment, a method for characterizing a PCD element is disclosed. The method includes providing a PCD element that includes a plurality of bonded diamond grains defining a plurality of pores therebetween. The method further includes conducting porosimetry on the PCD element to measure at least one pore characteristic of the plurality of pores of the PCD element. In an embodiment, the method additionally includes adjusting one or more process parameters for fabricating the PCD element at least partially based on the measured at least one pore characteristic. In an embodiment, the method additionally includes fabricating a second PCD element in an adjusted HPHT process that employs the adjusted one or more process parameters.

In an embodiment, a method of performing quality control on a PCD element is disclosed. The method includes fabricating a PCD element in an HPHT process, at least partially leaching a catalyst from the PCD element to form an at least partially porous PCD element, and conducting porosimetry on the at least partially porous PCD element to measure at least one pore characteristic thereof. The method further includes rejecting the at least partially porous PCD element if the measured at least one pore characteristic is outside an acceptable range, or accepting the at least partially porous PCD element if the measured at least one pore characteristic is within the acceptable range.

In another embodiment, a method of performing quality control on a PCD element is disclosed. The method includes fabricating the PCD element in an HPHT process, at least partially leaching a catalyst from the PCD element to form an at least partially porous PCD element, and conducting porosimetry on the at least partially porous PCD element to measure at least one pore characteristic thereof. The method further includes grouping the at least partially porous PCD element with other PCD elements if the at least one pore characteristic is within an acceptable range.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is a flow diagram illustrating a method for characterizing an at least partially porous PCD element according to an embodiment.

FIG. 2 is a flow diagram illustrating a method for adjusting one or more process parameters used in a method for manufacturing a PCD element according to an embodiment.

FIG. 3 is a flow diagram illustrating a method for performing quality control on a PCD element according to an embodiment.

FIG. 4A is a schematic diagram of an example magnetic saturation apparatus configured to magnetize a PCD element approximately to saturation.

FIG. 4B is a schematic diagram of an example magnetic saturation measurement apparatus configured to measure a saturation magnetization of a PCD element.

FIG. 5 is a schematic diagram of an example coercivity measurement apparatus configured to determine coercivity of a PCD element.

FIG. 6A is a cross-sectional view of an embodiment of a PDC.

FIG. 6B is a schematic illustration of a method of fabricating the PDC shown in FIG. 6A according to an embodiment.

FIG. 7A is an isometric view of an embodiment of a rotary drill bit that may employ one or more of the PDCs that have been fabricated by any of the processes disclosed herein.

FIG. 7B is a top elevation view of the rotary drill bit shown in FIG. 7A.

### DETAILED DESCRIPTION

Embodiments of the invention relate to methods for measuring at least one pore characteristic of a PCD element (e.g., a PCD table) via porosimetry and, for example, using the measurement to adjust one or more process parameters for fabricating a PCD element and/or for quality control on such a PCD element that are suitable for use in a subterranean drilling apparatus. Measurement of the at least one pore characteristic may be used to adjust process parameters for fabricating a PCD element to, for example, accurately control leaching processing of the PCD element, catalyst concentration therein, and extent of diamond-to-diamond bonding therethrough, or perform quality control on the PCD element. A PCD element includes a plurality of directly bonded-together diamond grains (e.g., sp³ diamond-to-diamond bonding) that define a plurality of interstitial regions. A metal-solvent catalyst, a nonmetallic catalyst, other infiltrant (metallic or nonmetallic), or combinations thereof occupies at least a portion of the plurality of interstitial regions of the PCD element.

### Embodiments of Methods for Conducting Porosimetry on a PCD Element and Quality Control on a PCD Element

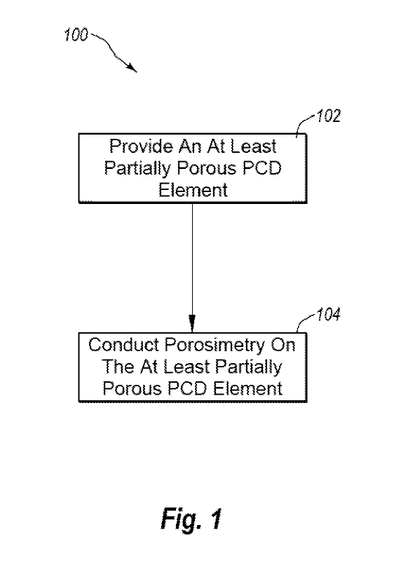

Embodiments disclosed herein are generally directed to a method for characterizing a PCD element. FIG. 1 illustrates a method 100 for characterizing a PCD element according to an embodiment. The method 100 includes an act 102 of providing an at least partially porous PCD element that includes a plurality of bonded diamond grains defining a plurality of pores therebetween, such as an at least partially leached PCD disk that may be bonded or un-bonded to a substrate. The method 100 further includes an act 104 of conducting porosimetry on the PCD element to measure at least one pore characteristic of the plurality of pores of the PCD element. For example, the at least one pore characteristic includes one or more of average pore size, median pore size, pore size distribution, total pore volume, average pore throat diameter, median pore throat diameter, total pore area, porosity (i.e., fraction of the volume of voids to the total volume of the PCD element), or other characteristic related to porosity such as density (e.g., bulk density or apparent skeletal density) of the PCD element.

The porosimetry technique employed in act 104 may be mercury porosimetry, helium porosimetry, or other suitable porosimetry technique in which a pressure necessary to introduce a non-wetting fluid (e.g., mercury) into the at least partially porous PCD element is inversely proportional to the size of the pores. In practice, the at least partially porous PCD element sample may be placed in a bulb penetrometer that is evacuated to remove air and volatile substances. The bulb penetrometer may then be filled with a medium (e.g., mercury or helium) and pressurized in discrete steps. The incremental volume of mercury that infiltrates the at least partially porous PCD element may be determined for each pressure increment to allow determination of any of the aforementioned pore characteristics. For example, a Micromeritics Autopore IV Model 9500 Mercury Porosimeter may be employed in any of the embodiments disclosed herein.

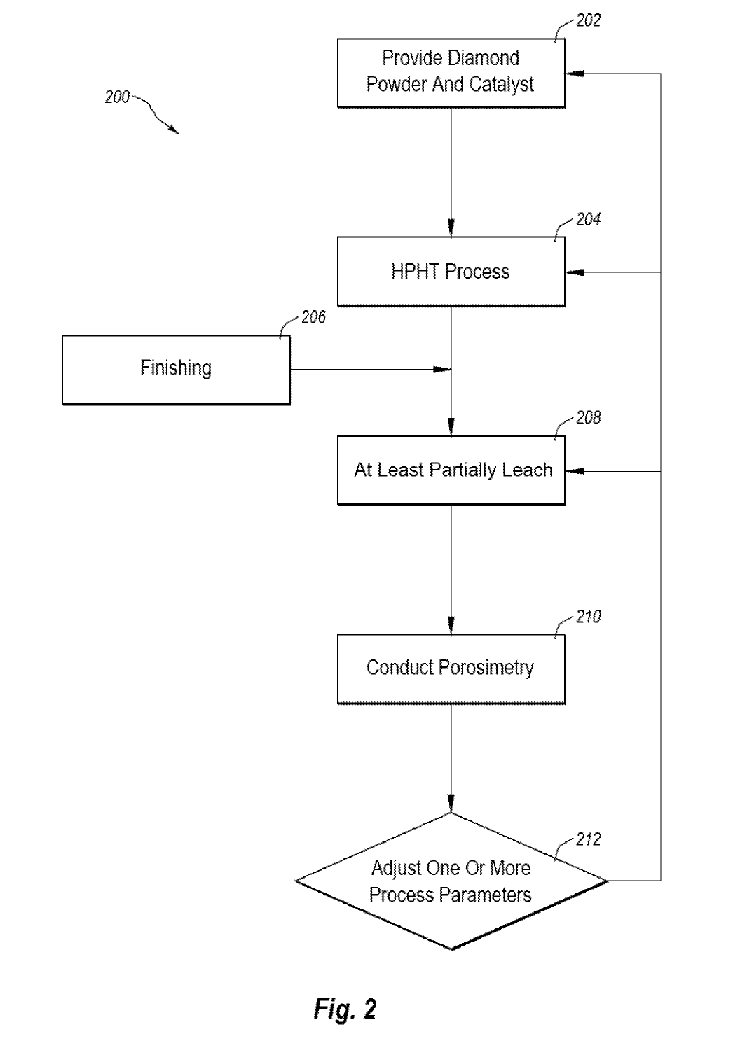

Referring now to FIG. 2, a method 200 for adjusting one or more process parameters used in the fabrication of a PCD element is illustrated according to an embodiment. The method 200 includes an act 202 of providing diamond powder and a catalyst, and an act 204 of subjecting the diamond powder and the catalyst to an HPHT process to fabricate a PCD element. After act 204, optionally, one or more surfaces of the PCD element may be at least partially finished in act 206 using techniques such as, but not limited to, lapping, centerless grinding, machining (e.g., electro-discharge machining), or combinations of the foregoing finishing processes. For example, in act 206, the PCD element may be shaped to a selected geometry, such as shaping the PCD element to form a disk with an edge chamfer. After either the HPHT process (act 204) or the finishing process (act 206), the PCD element may be at least partially leached in act 208 to form an at least partially porous PCD element. The leaching may be used to at least partially remove metal-solvent catalyst from the PCD element that was used to catalyze formation of PCD to form an at least partially porous PCD element that includes a plurality of bonded diamond grains defining a plurality of pores interstitially therethrough. It should be noted that as an alternative or in addition to performing act 206 prior to act 208 of leaching, the act 206 of finishing may also be performed after the act 208 of leaching.

The method 200 further includes an act 210 of conducting porosimetry on the PCD element to measure at least one pore characteristic of the PCD element. For example, the at least one pore characteristic includes one or more of average pore size, median pore size, pore size distribution, total pore volume, average pore throat diameter, median pore throat diameter, total pore area, porosity (i.e., fraction of the volume of voids to the total volume of the PCD element), or other characteristic related to porosity such as density (e.g., bulk density or apparent skeletal density). As discussed above, in an embodiment, the porosimetry technique may be mercury or helium porosimetry. The measured at least one pore characteristic may be used to adjust one or more process parameters for fabricating the PCD element to, for example, adjust the leaching process (act 208), adjust parameters of the HPHT process, adjust the size of the diamond particles provided, or combinations of the foregoing in order to provide accurate control of catalyst concentration, the extent of diamond-to-diamond bonding in the PCD element, or combinations of the foregoing. Thus, in act 212, one or more process parameters may be adjusted, such as adjusting the precursor diamond powder average particle size and/or distribution and/or catalyst provided in act 202, the HPHT process parameters used in act 204, the finishing process in act 206, the leaching process in act 208, or combinations of the foregoing. By tailoring the average diamond particle size and distribution, leaching speed and/or effectiveness to a given depth or extent may be increased. Additionally, by controlling the catalyst concentration so it is sufficiently low and HPHT process conditions to impart a high-degree of diamond-to-diamond bonding in the PCD element (for a given diamond particle formulation), the PCD element may exhibit one or more improved performance characteristics, such as increased wear resistance, reduced cracking, improved thermal stability, or combinations of the foregoing. For example, at elevated temperature and in the presence of a metal-solvent catalyst, some of the diamond grains in the PCD element may undergo a chemical breakdown or back-conversion to graphite via interaction with the metal-solvent catalyst. At elevated high temperatures, portions of the diamond grains may transform to carbon monoxide, carbon dioxide, graphite, or combinations thereof, causing degradation of the mechanical properties of the PCD table. In another embodiment, relatively high catalyst concentration in the PCD element may reduce thermal stability of the PCD element due to the fact that the diamond grains and the metal-solvent catalyst of the PCD element have different coefficients of thermal expansion that can induce cracking of the PCD element. A new PCD element may be fabricated using the adjusted process parameters in a modified HPHT process.

In another embodiment, the act 210 of conducting porosimetry may be performed on the PCD element without having leached the PCD element. In such an embodiment, helium porosimetry or other suitable porosimetry technique may capable of eluting through very small pores formed in the PCD element.

In an embodiment, the method 200 includes fabricating a PDC in an HPHT process to form a PCD table bonded to a first substrate. In such an embodiment, a catalyst may be at least partially leached from a PCD table of the PDC in a leaching process to form a leached region extending to a selected depth from one or more exterior surfaces, any of the disclosed pore characteristics may be measured in the leached region via porosimetry, and one or more process parameters of at least one of the leaching process or the HPHT process may be adjusted at least partially based on the measured pore characteristic(s).

In an embodiment, the method 200 further includes optionally removing the leached region from the PCD table by, for example, grinding away the unleached region. In such an embodiment, measuring the at least one pore characteristic of at least the leached region of the PCD table may include measuring the at least one pore characteristic of only the leached region. In other embodiments, the leached region does not need to be removed to conduct the porosimetry on the PCD table.

In an embodiment, the first substrate that is bonded to the PCD table includes tungsten carbide, chromium carbide, or combinations thereof cemented with iron, nickel, cobalt, other metals, or alloys thereof. For example, the first substrate may comprise cobalt-cemented tungsten carbide.

In an embodiment, the method further includes separating the PCD table from the first substrate, adjusting one or more parameters of the HPHT process at least partially based on the measured at least one pore characteristic to make a modified HPHT process, and bonding the at least partially leached PCD table to a second substrate using a modified HPHT process. For example, the second substrate may also comprise tungsten carbide, chromium carbide, or combinations thereof cemented with iron, nickel, cobalt, other metals, or alloys thereof, such as a cobalt-cemented tungsten carbide substrate.

Suitable examples of process parameters that may be adjusted based on the measured at least one pore characteristic include, but are not limited to, HPHT sintering temperature, HPHT sintering pressure, precursor diamond particle size used to form the PCD element, catalyst composition, amount of catalyst used in the fabrication of the PCD element, acid composition used to leach catalyst from the PCD element, pH of an acid composition used to leach catalyst from the PCD element, leaching time used in a leaching process to leach catalyst from the PCD element, leaching temperature used to leach catalyst from the PCD element, leaching pressure used to leach catalyst from the PCD element, combinations thereof, or another suitable process parameter. In an embodiment, the one or more process parameters affect synthesis of the diamond structure (e.g., the extent of diamond-to-diamond bonding) in the PCD element. In another embodiment, the process parameters affect wear resistance and/or thermal stability of the PCD element.

In an embodiment, the sintering temperature and/or the sintering cell pressure may be adjusted to affect the fabrication of the PCD element and/or affect the performance characteristics of the PCD element. As discussed in greater detail below, PCD elements may be fabricated by placing diamond particles into an HPHT cell assembly and subjecting the HPHT cell assembly and the diamond particles therein to diamond-stable HPHT conditions (e.g., about 1100° C. to about 2200° C., or about 1200° C. to about 1450° C. and a pressure of at least about 5 GPa, 7.5 GPa to about 15 GPa, about 9 GPa to about 12 GPa, or about 10 GPa to about 12.5 GPa) for a time sufficient to sinter the diamond particles together in the presence of a catalyst. The pressure values employed in the HPHT processes disclosed herein refer to the cell pressure in a pressure transmitting medium of the HPHT cell assembly at room temperature (e.g., about 25° C.) with application of pressure using an ultra-high pressure press and not the pressure applied to the exterior of the cell assembly. The actual pressure in the pressure transmitting medium at sintering temperature may be slightly higher. Metal-solvent catalyst may be infiltrated from substrate placed adjacent the diamond particles, provided from a thin layer of metal-solvent catalyst, mixed with the diamond particles, or combinations of the foregoing. Testing the pore characteristic(s) of an at least partially porous, at least partially leached PCD element provides a non-destructive testing technique that enables sintering parameters to be adjusted (e.g., raising/lowering the temperature and/or the pressure and/or altering the time in the pressure cell) to affect performance parameters, such as degree of diamond grain growth, extent of diamond-to-diamond bonding, the concentration of metal-solvent catalyst incorporated into the PCD during the HPHT process, leaching processing effectiveness, combinations thereof, or other suitable characteristic.

In another embodiment, the precursor diamond particle size used to form the PCD element may be adjusted based on measured pore characteristic(s) of fabricated PCD elements. The diamond particles used to fabricate the PCD element may exhibit an average particle size of, for example, about 50 μm or less, such as about 30 μm or less, about 20 μm or less, about 10 μm to about 18 μm or, about 15 μm to about 18 μm. In some embodiments, the average particle size of the diamond particles may be about 10 μm or less, such as about 2 μm to about 5 μm or submicron. Additionally, the diamond particles size may exhibit a unimodal, bimodal, or trimodal or greater particle size distribution. It is noted that the sintered diamond grain size in the PCD element may differ from the average particle size of the mass of diamond particles prior to sintering due to a variety of different physical processes, such as grain growth, diamond particle fracturing, carbon provided from another carbon source (e.g., dissolved carbon in the metal-solvent catalyst), or combinations of the foregoing. Measuring one or more pore characteristics of fabricated PCD elements may allow manufacturing processes to be adjusted such that starting diamond particle size and/or distribution is selected in order to achieve desired performance characteristics and/or a selected sintered diamond grain size in the PCD element.

In yet another embodiment, one or more of a catalyst composition, an amount of catalyst used in the fabrication of the PCD element, or a catalyst concentration in the fabricated and leached PCD element may be measured and adjusted based on the measured pore characteristic(s) of the PCD element. Metal-solvent catalyst concentration and/or catalyst composition may affect performance of the PCD elements by affecting, for example, thermal stability of the PCD element, crack resistance, and chemical stability.

Metal-solvent catalyst may be introduced into the PCD element by a number of processes. If, for example, the substrate includes a metal-solvent catalyst, the metal-solvent catalyst may liquefy and infiltrate the mass of precursor diamond particles during the HPHT process to promote growth between adjacent diamond particles of the mass of diamond particles to form the PCD element. For example, if the substrate is a cobalt-cemented tungsten carbide substrate, cobalt from the substrate may be liquefied and infiltrate the mass of diamond particles to catalyze formation of the PCD element. Sintering temperature and/or pressure and precursor diamond particle size may affect the amount of catalyst that infiltrates into the PCD element during the HPHT process.

Catalyst concentration in the PCD element may also be altered on the back end of the process by leaching at least a portion of the catalyst from the PCD element using an acid leaching process. Acid leaching is a time consuming and often difficult process. Monitoring the catalyst concentration in the PCD element before, during, and after the leaching process using the measured pore characteristic(s) enables the leaching process parameters to be adjusted in order to achieve desired characteristics in the PCD element and/or a selected catalyst concentration in the PCD element after leaching.

Based on the measured pore characteristic(s) of the at least partially porous PCD element, one or more of acid composition used to leach catalyst from the PCD element, pH of an acid composition used to leach catalyst from the PCD element, leaching time used in a leaching process to leach catalyst from the PCD element, leaching temperature used to leach catalyst from the PCD element, leaching pressure used to leach catalyst from the PCD element, diamond particle size and/or size distribution, or combinations thereof may be adjusted.

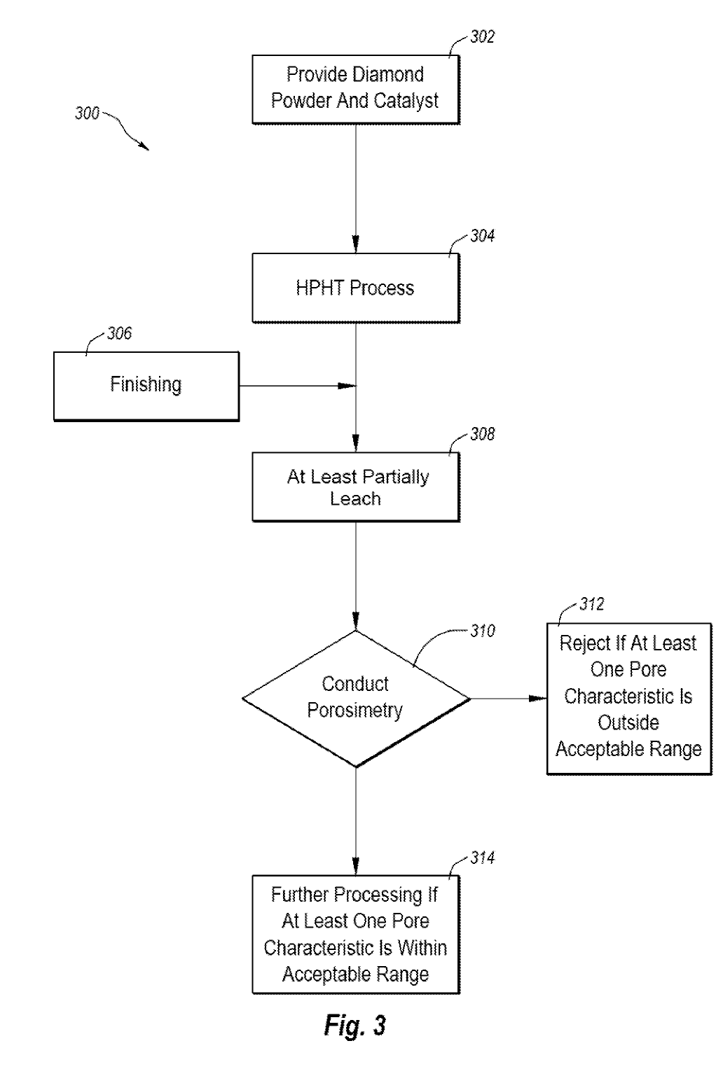

Referring now to FIG. 3, a method 300 for performing quality control on a PCD element is illustrated according to an embodiment. The method 300 illustrated in FIG. 3 may employ measurements of the at least one pore characteristics of PCD elements fabricated in an HPHT process to determine if a PCD element is suitable for further processing, re-processing, or use. For example, the at least one pore characteristic includes one or more of average pore size, median pore size, pore size distribution, total pore volume, average pore throat diameter, median pore throat diameter, total pore area, porosity, or other characteristic related to porosity such as density (e.g., bulk density or apparent skeletal density) of the at least partially porous PCD element and may be correlated with leaching effectiveness, such as completion of catalyst removal from the un-leached PCD element in a leaching process. As discussed above, catalyst concentration in the PCD element may be used to predict the potential wear resistance and/or thermal stability of the PCD element.

The method 300 includes an act 302 of providing diamond powder and a catalyst, and an act 304 of subjecting the diamond powder and the catalyst to an HPHT process to fabricate a PCD element. After the HPHT process, optionally, one or more surfaces of the PCD element may be at least partially finished in act 306 using techniques, such as, lapping, centerless grinding, or machining (e.g., electro-discharge machining). After either the HPHT process or the finishing, in act 308, the PCD element may be at least partially leached to at least partially remove the metal-solvent catalyst from the PCD element to form an at least partially porous PCD element.

After leaching, in act 310, at least one pore characteristic of the at least partially porous PCD element are measured using porosimetry, such as mercury porosimetry or other suitable porosimetry technique. For example, the at least one pore characteristic includes one or more of average pore size, pore size distribution, total pore volume, average pore diameter, or density of the at least partially porous PCD element, and may be correlated with leaching effectiveness, such as completion of catalyst removal in a leaching process. According to an embodiment, in act 312, the at least partially porous PCD element is rejected if the measured at least one pore characteristic is out of an acceptable range, such as the pore size being too small or too large. In an embodiment, one or more process parameters used to fabricate the PCD element may be adjusted in accordance with the method 200 shown in FIG. 2 if the at least partially porous PCD element is rejected.

In another embodiment, in act 314, if the at least one pore characteristic is within the acceptable range, the at least partially porous PCD element may be accepted/deemed to be suitable for further processing. For example, if the at least partially porous PCD element passes porosimetry testing, the at least partially porous PCD element may be used as-is, finished using one or more techniques (e.g., lapping, centerless grinding, or electro-discharge machining) or the at least partially porous PCD element may be re-attached to a second substrate (e.g., a cobalt-cemented tungsten carbide substrate) in a second HPHT process or a brazing process.

In another embodiment, the act 310 of conducting porosimetry may be performed on the PCD element without having leached the PCD element (i.e., an unleached PCD element). In such an embodiment, helium porosimetry or other suitable porosimetry technique may capable of eluting through very small pores formed in the PCD element.

In a more specific embodiment, the method 300 may include fabricating a PCD element on a first substrate in an HPHT process, separating the PCD element from the first substrate, at least partially leaching a metal-solvent catalyst from the separated PCD element to form an at least partially leached and at least partially porous PCD element (e.g., an at least partially leached PCD disk that is not bonded to a substrate), and measuring any of the disclosed pore characteristics of the at least partially porous PCD element via porosimetry. If the pore characteristic(s) in the separated/at least partially porous PCD element is within an acceptable range/limit, then further processing may include re-attaching the at least partially porous PCD element to a second substrate in a second HPHT process to form a PDC, followed by further processing such as lapping/centerless grinding/machining the PDC, and leaching the re-attached PCD element. For example, during re-attachment of the at least partially leached PCD element, a metallic infiltrant from the second substrate may infiltrate into the interstitial regions between bonded diamond grains of the at least partially leached PCD element, and the metallic infiltrant may be at least partially removed thereafter in a leaching process. In an embodiment, the first substrate that is bonded to the PCD table includes tungsten carbide, chromium carbide, or combinations thereof cemented with iron, nickel, cobalt, or alloys thereof. For example, the first substrate may comprise cobalt-cemented tungsten carbide. For example, the second substrate may also comprise tungsten carbide, chromium carbide, or combinations thereof cemented with iron, nickel, cobalt, or alloys thereof, such as a cobalt-cemented tungsten carbide substrate.

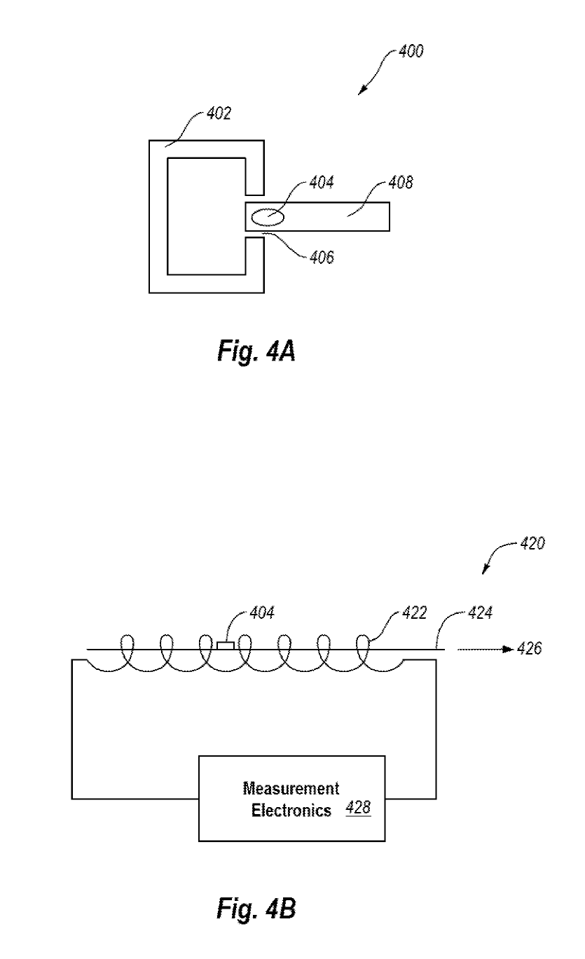

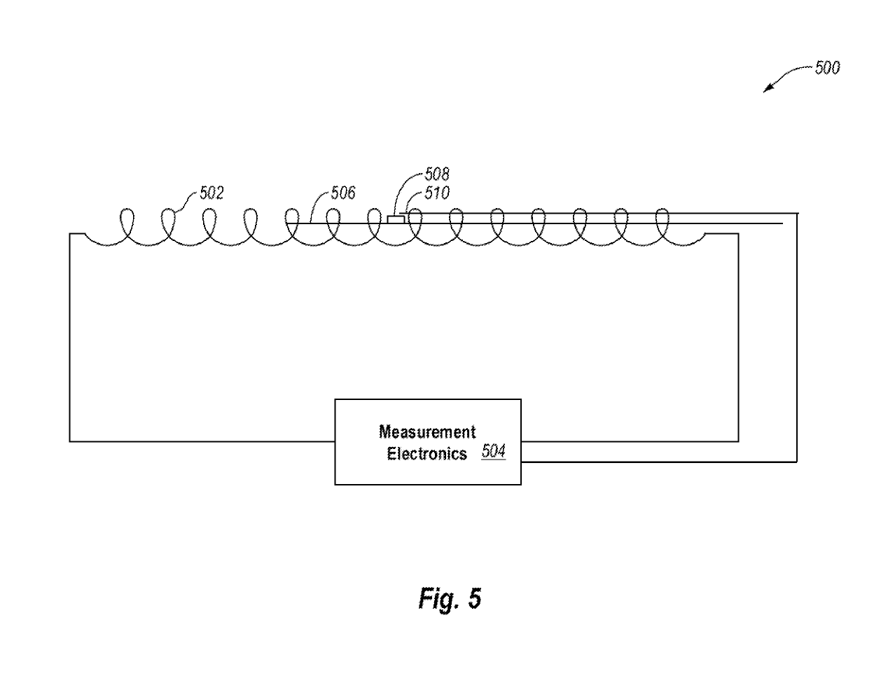

In any of the embodiments disclosed herein, prior to leaching the PCD element, the un-leached PCD element may be characterized by magnetic testing. For example, suitable examples of magnetic characteristics that may be measured in any of the disclosed embodiments include, but are not limited to, magnetic saturation (e.g., specific magnetic saturation) and coercivity (e.g., specific coercivity). Magnetic saturation and coercivity may be measured using the example apparatuses and methods described below with respect to FIGS. 4A-5. Details about suitable magnetic testing techniques that may be employed in at least some of the embodiments disclosed herein are disclosed in U.S. Pat. No. 7,866,418, the disclosure of which is incorporated herein, in its entirety, by this reference.

In an embodiment, a metal-solvent catalyst concentration in the PCD element may be determined at least partially based on the measured magnetic saturation. In other embodiments, effectiveness of leaching may be characterized by measurement of the catalyst concentration via magnetic saturation measurements after leaching and compared with any of the pore characteristic measurements determined via porosimetry that may be taken before or after the magnetic measurements. Such comparison may enable verification of the accuracy of the pore characteristic measurement(s).

In any of the disclosed embodiments, a metal-solvent catalyst concentration in the PCD element may be determined at least partially based on measured magnetic saturation with the measurement performed either before or after a leaching process in which the metal-solvent catalyst is at least partially leached from the PCD element. In an embodiment, the leaching process may include leaching the metal-solvent catalyst from the PCD element to form an at least partially leached and at least partially porous PCD element. A suitable example of a leaching process may include immersing the PCD element for a selected period of time at a selected temperature in an acid solution including one or more acids selected from sulfuric acid, hydrochloric acid, nitric acid, aqua regia, hydrofluoric acid, and combinations thereof.

Measuring the one or more magnetic characteristics may include determining an extent of diamond-to-diamond bonding within the PCD element at least partially based on the measured coercivity, such as the measured specific coercivity. Coercivity measurements may be correlated to the extent of diamond-to-diamond bonding by determining the mean free path between neighboring diamond grains in the PCD element. That is, the magnitude of the measured coercivity has an inverse relationship to the mean free path between neighboring diamond grains of the PCD element. The mean free path may correlate to the average distance between neighboring diamond grains of the PCD element, and thus may be indicative of the extent of diamond-to-diamond bonding in the PCD element. A relatively smaller mean free path, in well-sintered PCD, may indicate relatively more diamond-to-diamond bonding.

As discussed above, many physical characteristics of a PCD element may be correlated with certain measured magnetic properties of the PCD element because the metal-solvent catalyst therein may be ferromagnetic. For example, the amount of the metal-solvent catalyst present in the PCD element may be correlated with the measured specific magnetic saturation of the PCD element. A relatively larger specific magnetic saturation indicates relatively more metal-solvent catalyst in the PCD element.

The mean free path between neighboring diamond grains of the PCD element may be correlated with the measured coercivity of the PCD element. A relatively large coercivity indicates a relatively smaller mean free path. The mean free path is representative of the average distance between neighboring diamond grains of the PCD element, and thus may be indicative of the extent of diamond-to-diamond bonding in the PCD. A relatively smaller mean free path, in well-sintered PCD, may indicate relatively more diamond-to-diamond bonding. Generally, as the sintering pressure that is used to form the PCD element increases, the coercivity may increase and the magnetic saturation may decrease.

As merely one example, ASTM B886-03 (2008) and ASTM B887-03 (2008) e1 provide suitable standards for measuring the specific magnetic saturation and the coercivity of the PCD element. Although both ASTM B886-03 (2008) and ASTM B887-03 (2008) e1 are directed to standards for measuring magnetic properties of cemented carbide materials, either standard may be used to determine the magnetic properties of a PCD element. A KOERZIMAT CS 1.096 instrument (commercially available from Foerster Instruments of Pittsburgh, Pa.) is one suitable instrument that may be used to measure the specific magnetic saturation and the coercivity of a PCD element. However, other commercially available instruments may also be used.

FIGS. 4A, 4B, and 5 schematically illustrate the manner in which the specific magnetic saturation and the specific coercivity of the PCD may be determined using an apparatus, such as the KOERZIMAT CS 1.096 instrument. FIG. 4A is a schematic diagram of an example magnetic saturation apparatus 400 configured to magnetize a PCD element to saturation. The magnetic saturation apparatus 400 includes a saturation magnet 402 of sufficient strength to magnetize a PCD element 404 to saturation. The saturation magnet 402 may be a permanent magnet or an electromagnet. In the illustrated embodiment, the saturation magnet 402 is a permanent magnet that defines an air gap 406, and the PCD element 404 may be positioned on a sample holder 408 within the air gap 406. When the PCD element 404 is lightweight, it may be secured to the sample holder 408 using, for example, double-sided tape or other adhesive so that the PCD element 404 does not move responsive to the magnetic field from the saturation magnet 402 and the PCD element 404 is magnetized at least approximately to saturation.

Referring to the schematic diagram of FIG. 4B, after magnetizing the PCD element 404 at least approximately to saturation using the magnetic saturation apparatus 400, a magnetic saturation of the PCD element 404 may be measured using a magnetic saturation measurement apparatus 420. The magnetic saturation measurement apparatus 420 includes a Helmholtz measuring coil 422 defining a passageway dimensioned so that the magnetized PCD sample 404 may be positioned therein on a sample holder 424. Once positioned in the passageway, the sample holder 424 supporting the magnetized PCD sample 404 may be moved axially along an axis direction 426 to induce a current in the Helmholtz measuring coil 422. Measurement electronics 428 are coupled to the Helmholtz measuring coil 422 and configured to calculate the magnetic saturation based upon the measured current passing through the Helmholtz measuring coil 422. The measurement electronics 428 may also be configured to calculate a weight percentage of magnetic material in the PCD element 404 when the composition and magnetic characteristics of the metal-solvent catalyst in the PCD element 404 are known, such as with iron, nickel, cobalt, and alloys thereof. Specific magnetic saturation may be calculated based upon the calculated magnetic saturation and the measured weight of the PCD element 404.

The amount of metal-solvent catalyst in the PCD element 404 may be determined using a number of different analytical techniques and correlated with the measured specific magnetic saturation. For example, energy dispersive spectroscopy (e.g., EDS), wavelength dispersive x-ray spectroscopy (e.g., WDX), Rutherford backscattering spectroscopy, or combinations thereof may be employed to determine the amount of metal-solvent catalyst in the PCD element 404.

FIG. 5 is a schematic diagram of an example coercivity measurement apparatus 500 configured to determine a coercivity of a PCD element. The coercivity measurement apparatus 500 includes a coil 502 and measurement electronics 504 coupled to the coil 502. The measurement electronics 504 are configured to pass a current through the coil 502 so that a magnetic field is generated. A sample holder 506 having a PCD element 508 thereon may be positioned within the coil 502. A magnetization sensor 510 configured to measure a magnetization of the PCD element 508 may be coupled to the measurement electronics 504 and positioned in proximity to the PCD element 508.

During testing, the magnetic field generated by the coil 502 magnetizes the PCD element 508 at least approximately to saturation. Then, the measurement electronics 504 apply a current so that the magnetic field generated by the coil 502 is increasingly reversed. The magnetization sensor 510 measures a magnetization of the PCD element 508 resulting from application of the reversed magnetic field to the PCD element 508. The measurement electronics 504 determine the coercivity of the PCD element 508, which is a measurement of the strength of the reversed magnetic field at which the magnetization of the PCD element 508 is zero.

### Embodiments for Fabricating PCD Elements, PDCs, and Resulting Structures

The PCD elements characterized by the disclosed porosimetry and/or magnetic characterization techniques may be formed by sintering a mass of a plurality of diamond particles in the presence of a metal-solvent catalyst. The diamond particles may exhibit an average particle size of about 50 μm or less, such as about 30 μm or less, about 20 μm or less, about 10 μm to about 18 μm or, about 15 μm to about 18 μm. In some embodiments, the average particle size of the diamond particles may be about 10 μm or less, such as about 2 μm to about 5 μm or submicron.

In an embodiment, the diamond particles of the mass of diamond particles may comprise a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the mass of diamond particles may include a portion exhibiting a relatively larger size (e.g., 30 μm, 20 μm, 15 μm, 12 μm, 10 μm, 8 μm) and another portion exhibiting at least one relatively smaller size (e.g., 6 μm, 5 μm, 4 μm, 3 μm, 2 μm, 1 μm, 0.5 μm, less than 0.5 μm, 0.1 μm, less than 0.1 μm). In one embodiment, the mass of diamond particles may include a portion exhibiting a relatively larger size between about 10 μm and about 40 μm and another portion exhibiting a relatively smaller size between about 1 μm and 4 μm. In some embodiments, the mass of diamond particles may comprise three or more different sizes (e.g., one relatively larger size and two or more relatively smaller sizes), without limitation.

It is noted that the as-sintered diamond grain size may differ from the average particle size of the mass of diamond particles prior to sintering due to a variety of different physical processes, such as grain growth, diamond particle fracturing, carbon provided from another carbon source (e.g., dissolved carbon in the metal-solvent catalyst), or combinations of the foregoing. The metal-solvent catalyst (e.g., iron, nickel, cobalt, or alloys thereof) may be provided in particulate form mixed with the diamond particles, as a thin foil or plate placed adjacent to the mass of diamond particles, from a cemented carbide substrate including a metal-solvent catalyst, or combinations of the foregoing.

In order to efficiently sinter the mass of diamond particles, the mass may be enclosed in a pressure transmitting medium, such as a refractory metal can, graphite structure, pyrophyllite, combinations thereof, or other suitable pressure transmitting structure to form a cell assembly. The cell assembly, including the pressure transmitting medium and mass of diamond particles therein, is subjected to an HPHT process using an ultra-high pressure press at a temperature of at least about 1000° C. (e.g., about 1100° C. to about 2200° C., or about 1200° C. to about 1450° C.) and a pressure in the pressure transmitting medium of at least about 5 GPa (e.g., about 5 GPa, 7.5 GPa to about 15 GPa, about 9 GPa to about 12 GPa, or about 10 GPa to about 12.5 GPa) for a time sufficient to sinter the diamond particles together in the presence of the metal-solvent catalyst and form the PCD element comprising directly bonded-together diamond grains defining interstitial regions occupied by the metal-solvent catalyst. For example, the pressure in the pressure transmitting medium employed in the HPHT process may be at least about 5 GPa, at least about 7.5 GPa, at least about 8.0 GPa, at least about 9.0 GPa, at least about 10.0 GPa, at least about 11.0 GPa, at least about 12.0 GPa, or at least about 14 GPa. The pressure values employed in the HPHT processes disclosed herein refer to the cell pressure in the pressure transmitting medium at room temperature (e.g., about 25° C.) with application of pressure using an ultra-high pressure press and not the pressure applied to exterior of the cell assembly. The actual pressure in the pressure transmitting medium at sintering temperature may be slightly higher.

In an embodiment, the porosimetry and magnetic characterization techniques described above may be used to characterize the PCD element and adjust the HPHT process and precursor materials used to fabricate the PCD element to obtain a PCD element with specific performance characteristics such as thermal stability, wear resistance, leachability, among other characteristics. In another embodiment, the porosimetry and magnetic characterization techniques described above may be used to characterize the PCD element and determine which PCD elements are suitable for further processing and which should be rejected. In an embodiment described in greater detail above, PCD elements having a catalyst concentration that exceeds a selected limit may be rejected from further processing. In a further embodiment, PCD elements may be segregated/grouped by ranges of porosity measurements, such as small, medium, large, etc., which may be correlated with wear resistance, thermal stability, or both. For example, the at least partially porous PCD element may be grouped with other PCD elements if the at least one pore characteristic of the at least partially leached PCD element is within an acceptable range.

After fabricating the PCD element, the metal-solvent catalyst may be leached from the PCD element, if desired, via an acid leaching process. The porosimetry and magnetic characterization methods described above may be used to characterize the PCD element before and/or after leaching, such as the amount of metal-solvent catalyst remaining after leaching, and adjust the HPHT process, precursor materials, leaching process, or combinations thereof in order to design a process by which, for example, a selected amount of the metal-solvent catalyst remains after leaching.

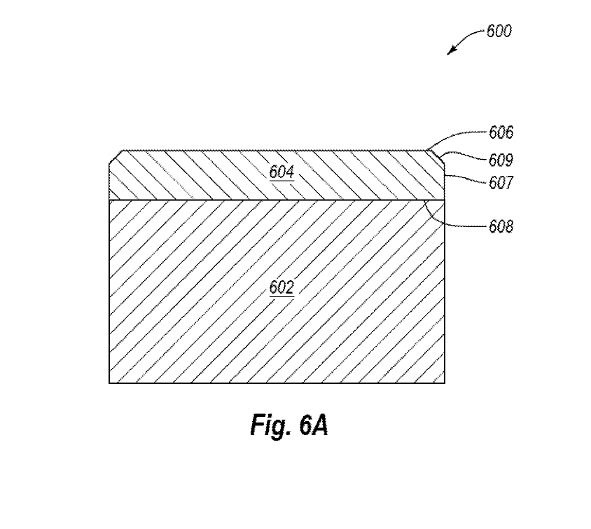

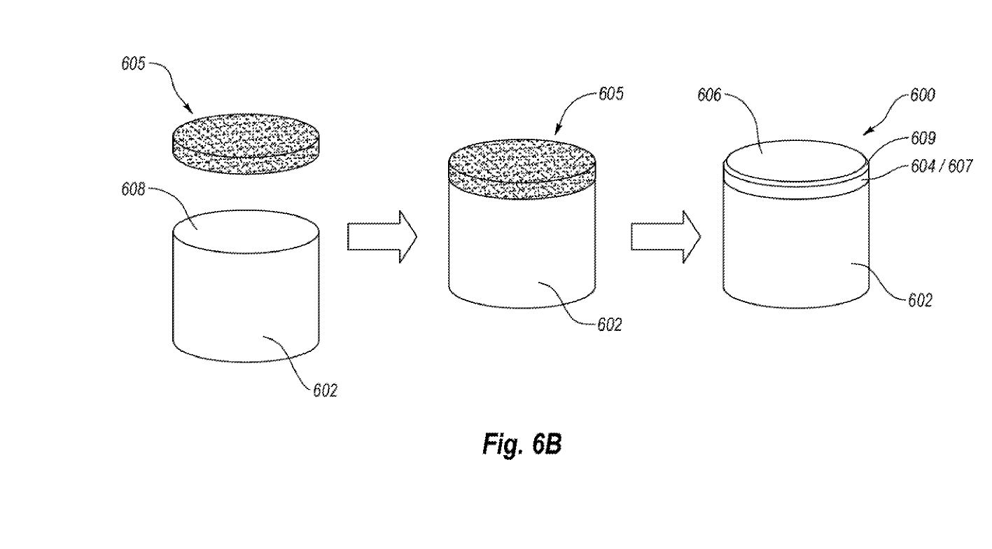

In another embodiment, a method of correlating any of the at least one pore characteristics to wear resistance, impact resistance, thermal stability, other performance characteristic, or combinations thereof is disclosed. For example, the at least one pore characteristic may be correlated to one or more of the foregoing performance characteristics and PCD elements/cutters may be grouped based on their correlated characteristics. The correlation may be performed by testing PCD elements measured to exhibit the at least one pore characteristic to determine their respective wear resistance, impact resistance, or thermal stability. For example, the wear resistance and thermal stability may be determined using a vertical turret lathe test to measure wear resistance or a mill test to measure thermal stability. Referring to FIG. 6A, the PCD elements may be employed in a PDC for cutting applications, bearing applications, or many other applications. FIG. 6A is a cross-sectional view of an embodiment of a PDC 600. The PDC 600 includes a substrate 602 bonded to a PCD table 604. The PCD table 604 may be formed of PCD in accordance with any of the PCD embodiments disclosed herein. The PCD table 604 exhibits at least one working surface 606 and at least one lateral dimension “D” (e.g., a diameter). Although FIG. 6A shows the working surface 606 as substantially planar, the working surface 606 may be concave, convex, or another nonplanar geometry. Furthermore, other regions of the PCD table 604 may function as a working region, such as a peripheral side surface and/or an edge 607 and/or an optional chamfer 609 that extends between the working surface 606 and the peripheral side surface 607. The substrate 602 may be generally cylindrical or another selected configuration, without limitation. Although FIG. 6A shows an interfacial surface 608 of the substrate 602 as being substantially planar, the interfacial surface 608 may exhibit a selected nonplanar topography, such as a grooved, ridged, or other nonplanar interfacial surface. The substrate 602 may include, without limitation, cemented carbides, such as tungsten carbide, titanium carbide, chromium carbide, niobium carbide, tantalum carbide, vanadium carbide, or combinations thereof cemented with iron, nickel, cobalt, or alloys thereof. For example, in one embodiment, the substrate 602 comprises cobalt-cemented tungsten carbide.

FIG. 6B is a schematic illustration of an embodiment of a method for fabricating the PDC 600 shown in FIG. 6A. Referring to FIG. 6B, a diamond volume 605 is positioned adjacent to the interfacial surface 608 of the substrate 602. For example, the diamond volume 605 may be an at least partially leached PCD table or a mass of diamond particles having any of the above-mentioned average particle sizes and distributions (e.g., an average particle size of about 50 μm or less). As previously discussed, the substrate 602 may include a metal-solvent catalyst. The diamond volume 605 and substrate 602 may be subjected to an HPHT process using any of the conditions previously described with respect to sintering the PCD elements disclosed herein. The PDC 600 so-formed includes the PCD table 604 bonded to the interfacial surface 608 of the substrate 602. If the substrate 602 includes a metal (e.g., a metal-solvent catalyst) and the diamond volume 605 is a mass of diamond particles, the metal may liquefy and infiltrate the mass of diamond particles to promote growth between adjacent diamond particles of the mass of diamond particles to form the PCD table 604 comprised of a body of bonded diamond grains having the infiltrated metal interstitially disposed between bonded diamond grains. For example, if the substrate 602 is a cobalt-cemented tungsten carbide substrate, cobalt from the substrate 602 may be liquefied and infiltrate the mass of diamond particles of the PCD table 604.

In other embodiments, the diamond volume 605 is a PCD table that was separately formed using an HPHT sintering process (i.e., a pre-sintered PCD table) and, subsequently, bonded to the interfacial surface 608 of the substrate 602 by brazing, using a separate HPHT bonding process, or any other suitable joining technique, without limitation.

In any of the embodiments disclosed herein, substantially all or a selected portion of the metal-solvent catalyst may be removed (e.g., via leaching) from the PCD table 604. In an embodiment, metal-solvent catalyst in the PCD table 604 may be removed to a selected depth from at least one exterior working surface (e.g., the working surface 606 and/or a sidewall working surface of the PCD table 604) so that only a portion of the interstitial regions are occupied by metal-solvent catalyst. For example, substantially all or a selected portion of the metal-solvent catalyst may be removed from the PCD table 604 of the PDC 600 to a selected depth from the working surface 606.

In some embodiments, the PCD table 604 may be separated from the substrate 602. The separated PCD table may be characterized by one or more of the disclosed pore and/or magnetic characterization techniques. In other embodiments, the PCD table 604 may be characterized by the disclosed pore and/or magnetic characterization techniques while still attached to the substrate 602 in leached or unleached form. The HPHT process, precursor diamond particles, metal-solvent catalyst, or combinations of the foregoing may be modified based at least partially on the measured pore and/or magnetic characteristics.

In another embodiment, a PCD table may be fabricated in a first HPHT process, leached to remove substantially all of the metal-solvent catalyst from the interstitial regions between the bonded diamond grains, and subsequently bonded to a substrate in a second HPHT process. For example, the PCD table may be at least partially leached to remove metal-solvent catalyst therefrom, characterized by one or more of the disclosed pore and/or magnetic characterization techniques, and the first HPHT process, precursor materials, and leaching process may be adjusted to obtain an at least partially leached PCD table with a controlled amount of residual metal-solvent catalyst therein.

In the second HPHT process, an infiltrant from, for example, a cemented carbide substrate may infiltrate into the interstitial regions from which the metal-solvent catalyst was depleted of a PCD table that was fabricated using an adjusted manufacturing process chosen at least partially based on the measured magnetic characteristics of other PCD tables. For example, the infiltrant may be cobalt that is swept-in from a cobalt-cemented tungsten carbide substrate. In an embodiment, the infiltrant may be leached from the infiltrated PCD table using a second acid leaching process following the second HPHT process.

### Applications for PCD Elements and PDCs

The PCD elements and PDCs that have been fabricated by a process that has been adjusted at least partially based on the disclosed pore and/or magnetic characterization techniques may be used in a number of different applications including, but not limited to, use in a rotary drill bit, a thrust-bearing apparatus, a radial bearing apparatus, a subterranean drilling system, and a wire-drawing die. The various applications discussed above are merely some examples of applications in which the PCD elements and PDCs may be used. Other applications are contemplated, such as employing the disclosed PCD elements and PDCs in friction stir welding tools.

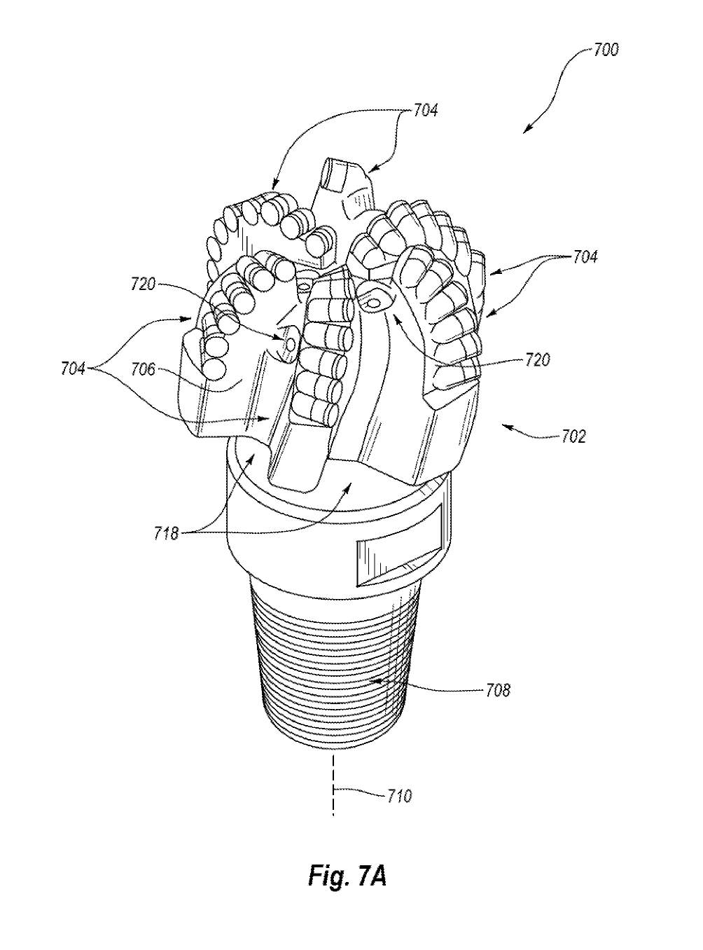

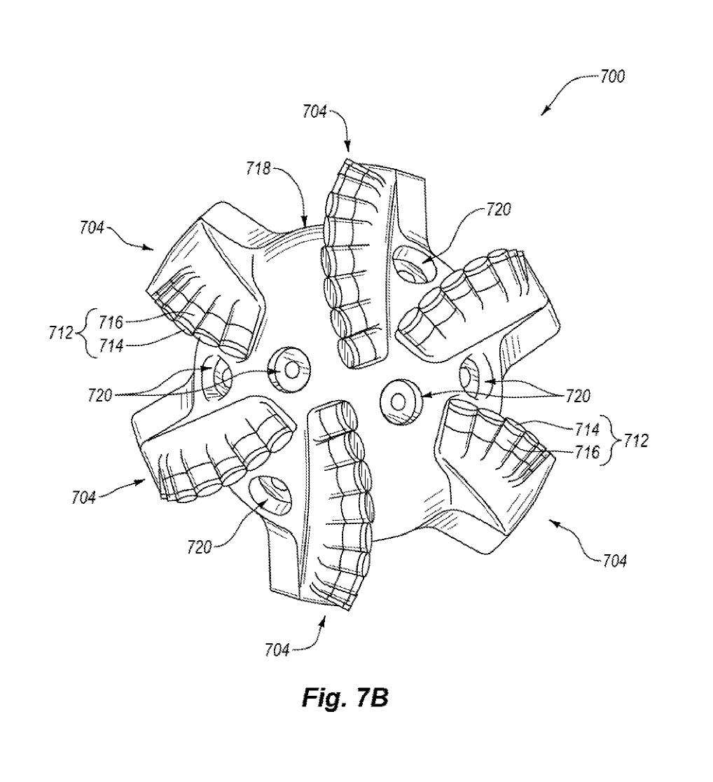

FIG. 7A is an isometric view and FIG. 7B is a top elevation view of an embodiment of a rotary drill bit 700. The rotary drill bit 700 includes at least one PDC configured according to any of the previously described PDC embodiments. The rotary drill bit 700 comprises a bit body 702 that includes radially and longitudinally extending blades 704 with leading faces 706, and a threaded pin connection 708 for connecting the bit body 702 to a drilling string. The bit body 702 defines a leading end structure for drilling into a subterranean formation by rotation about a longitudinal axis 710 and application of weight-on-bit. At least one PDC cutting element, such as the PDC 600 shown in FIG. 6A, may be affixed to the bit body 702. With reference to FIG. 7B, a plurality of PDCs 712 are secured to the blades 704. For example, each PDC 712 may include a PCD table 714 bonded to a substrate 716. Also, circumferentially adjacent blades 704 define so-called junk slots 718 therebetween, as known in the art. Additionally, the rotary drill bit 700 may include a plurality of nozzle cavities 720 for communicating drilling fluid from the interior of the rotary drill bit 700 to the PDCs 712.

FIGS. 7A and 7B merely depict an embodiment of a rotary drill bit that employs at least one cutting element comprising a PDC, without limitation. The rotary drill bit 700 is used to represent any number of earth-boring tools or drilling tools, including, for example, core bits, roller-cone bits, fixed-cutter bits, eccentric bits, bicenter bits, reamers, reamer wings, or any other downhole tool including PDCs, without limitation.

The PCD elements and/or PDCs disclosed herein (e.g., the PDC 600 shown in FIG. 6A) may also be utilized in applications other than rotary drill bits. For example, the disclosed PDC embodiments may be used in thrust-bearing assemblies, radial bearing assemblies, wire-drawing dies, artificial joints, machining elements, and heat sinks.

Thus, the embodiments of PCD elements and/or PDCs disclosed herein may be used in any apparatus or structure in which at least one conventional PDC is typically used. In one embodiment, a rotor and a stator, assembled to form a thrust-bearing apparatus, may each include one or more PCD elements and/or PDCs configured according to any of the embodiments disclosed herein and may be operably assembled to a downhole drilling assembly. U.S. Pat. Nos. 4,410,054; 4,560,014; 5,364,192; 5,368,398; and 5,480,233, the disclosure of each of which is incorporated herein, in its entirety, by this reference, disclose subterranean drilling systems within which bearing apparatuses utilizing the PCD elements and/or PDCs disclosed herein may be incorporated. The embodiments of PCD elements and/or PDCs disclosed herein may also form all or part of heat sinks, wire dies, bearing elements, cutting elements, cutting inserts (e.g., on a roller-cone-type drill bit), machining inserts, or any other article of manufacture as known in the art. Other examples of articles of manufacture that may use any of the PCD elements and/or PDCs disclosed herein are disclosed in U.S. Pat. Nos. 4,811,801; 4,268,276; 4,468,138; 4,738,322; 4,913,247; 5,016,718; 5,092,687; 5,120,327; 5,135,061; 5,154,245; 5,180,022; 5,460,233; 5,544,713; and 6,793,681, the disclosure of each of which is incorporated herein, in its entirety, by this reference.

The following working examples provide further detail in connection with the specific embodiments described above.

### Working Example 1

PDCs were formed according to the following process. A layer of diamond particles having an average particle size of about 19 μm was disposed on a cobalt-cemented tungsten carbide substrate. The layer of diamond particles and the cobalt-cemented tungsten carbide substrate were HPHT processed in a high-pressure cubic press at a temperature of about 1400° C. and a cell pressure of about 5-5.5 GPa to form a PDC comprising a PCD table integrally formed and bonded to the cobalt-cemented tungsten carbide substrate. The cobalt-cemented carbide substrate was ground away from each PCD table. The separated PCD tables were leached to remove the cobalt infiltrated therein from the cobalt-cemented carbide substrate during the HPHT process.

### Working Example 2

PCD tables were formed according to the process described above for working example 1 except the separated PCD tables were not leached.

### Working Example 3

PDCs were formed according to the following process. A layer of diamond particles having an average particle size of about 19 μm was disposed on a cobalt-cemented tungsten carbide substrate. The layer of diamond particles and the cobalt-cemented tungsten carbide substrate were HPHT processed in a high-pressure cubic press at a temperature of about 1400° C. and a cell pressure of at least 7.7 GPa to form a PDC comprising a PCD table integrally formed and bonded to the cobalt-cemented tungsten carbide substrate. The cobalt-cemented carbide substrate was ground away from each PCD table. The separated PCD tables were leached to remove the cobalt infiltrated therein from the cobalt-cemented carbide substrate during the HPHT process.

### Working Example 4

PCD tables were formed according to the process described above for working example 3 except the separated PCD tables were not leached.

### Porosimetry and Magnetic Measurements

Magnetic saturation measurements were performed on PCD tables of working examples 1-4 using the KOERZIMAT CS 1.096 instrument. Porosity, median pore diameter, and range of pore diameter measurements were performed on the PCD tables of working examples 1-4 using a Micromeritics Autopore IV Model 9500 Mercury Porosimeter. The table below provides a summary of the magnetic and porosimetry data collected on the PCD tables of working examples 1-4. The porosimetry measurements confirmed that the PCD tables of working examples 3 and 4, which were fabricated at a higher cell pressure, exhibited a smaller pore diameter, less overall porosity, and a smaller range of pore diameters than the PCD tables of working examples 1 and 2. Thus, the working example, demonstrate the ability to use porosimetry to measure pore characteristics of PCD tables.

| | | | | Pores smaller than 5 pm | | |
|---|---|---|---|---|---|---|
| | | | | | Median | Range of |
| Working | | Magnetic | Total | | Pore | Pore |
| Example | | Saturation | Porosity | Porosity | Diameter | Diameters |
| No. | State | (%) | (%) | (%) | (μm) | (μm) |
| 1a | Leached | 1.212 | 6.09 | 5.43 | 0.12 | 0.05 to 0.15 |
| 1b | Leached | 1.277 | 5.80 | 5.10 | 0.11 | 0.05 to 0.15 |
| 1c | Leached | 1.044 | 6.05 | 5.32 | 0.13 | 0.05 to 0.15 |
| 2a | Non- | 7.762 | 0.76 | 0 | N/A | N/A |
| | leached | | | | | |
| 2b | Non- | 7.914 | 1.67 | 0 | N/A | N/A |
| | leached | | | | | |
| 2c | Non- | 7.593 | 0.98 | 0 | N/A | N/A |
| | leached | | | | | |
| 3a | Leached | 1.306 | 3.97 | 3.49 | 0.05 | 0.02 to 0.08 |
| 3b | Leached | 1.685 | 4.38 | 3.80 | 0.04 | 0.02 to 0.08 |
| 3c | Leached | 1.433 | 4.87 | 3.34 | 0.04 | 0.02 to 0.08 |
| 4a | Non- | 6.55 | 0.71 | 0 | N/A | N/A |
| | leached | | | | | |
| 4b | Non- | 6.825 | 1.02 | 0 | N/A | N/A |
| | leached | | | | | |
| 4c | Non- | 6.475 | 1.16 | 0 | N/A | N/A |
| | leached | | | | | |

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A method for characterizing a polycrystalline diamond (“PCD”) element, the method comprising:
providing the PCD element that includes a plurality of bonded diamond grains defining a plurality of pores therebetween; and
conducting porosimetry on the PCD element to measure at least one pore characteristic of the plurality of pores of the PCD element.

2. The method of claim 1 wherein conducting porosimetry on the PCD element to measure at least one pore characteristic of the plurality of pores of the PCD element includes conducting mercury porosimetry or helium porosimetry on the PCD element.

3. The method of claim 1 wherein the at least one pore characteristic includes at least one of average pore size, median pore size, pore size distribution, total pore volume, average pore throat diameter, median pore throat diameter, total pore area, or porosity.

4. The method of claim 1, further comprising determining an extent of diamond-to-diamond bonding within the PCD element at least partially based on the measured at least one pore characteristic.

5. The method of claim 1 wherein the PCD element is at least partially leached or unleached.

6. The method of claim 1, further comprising adjusting one or more process parameters for fabricating the PCD element at least partially based on the measured at least one pore characteristic.

7. The method of claim 6 wherein the one or more process parameters affect at least one of wear resistance or thermal stability of the PCD element.

8. The method of claim 6 wherein adjusting one or more process parameters for fabricating the PCD element at least partially based on the measured at least one pore characteristic includes adjusting sintering temperature, sintering pressure, diamond particle size used to form the PCD element, catalyst composition, amount of catalyst used in the fabrication of the PCD element, acid composition used to leach catalyst from the PCD element, pH of an acid composition used to leach catalyst from the PCD element, leaching time used in a leaching process to leach catalyst from the PCD element, leaching temperature used to leach catalyst from the PCD element, leaching pressure used to leach catalyst from the PCD element, or combinations thereof.

9. The method of claim 6, further comprising fabricating a second PCD element in an adjusted high-pressure, high-temperature process that employs the adjusted one or more process parameters.

10. A method for adjusting one or more process parameters for fabricating a polycrystalline diamond (“PCD”) element for use in a subterranean drilling apparatus, the method comprising:
fabricating the PCD element in a high-pressure, high-temperature (“HPHT”) process;
at least partially leaching a catalyst from the PCD element to form an at least partially porous PCD element;
conducting porosimetry on the at least partially porous PCD element to measure at least one pore characteristic thereof; and
adjusting one or more process parameters of the HPHT process for fabricating the PCD element at least partially based on the measured at least one pore characteristic.

11. The method of claim 10 wherein fabricating a PCD element in an HPHT process includes sintering diamond powder in the presence of a catalyst.

12. The method of claim 10 wherein at least partially leaching a catalyst from the PCD element to form a porous PCD element includes immersing the PCD element for a selected period of time at a selected temperature in an acid solution including at least one acid selected from the group consisting of sulfuric acid, hydrochloric acid, nitric acid, aqua regia, and hydrofluoric acid.

13. The method of claim 10 wherein the one or more process parameters affect at least one of wear resistance or thermal stability of the PCD element.

14. The method of claim 10 wherein the at least one pore characteristic includes at least one of average pore size, median pore size, pore size distribution, total pore volume, average pore throat diameter, median pore throat diameter, total pore area, or porosity.

15. The method of claim 10 wherein adjusting one or more process parameters for fabricating the PCD element at least partially based on the measured at least one pore characteristic includes adjusting sintering temperature, sintering pressure, diamond particle size used to form the PCD element, catalyst composition, amount of catalyst used in the fabrication of the PCD element, acid composition used to leach catalyst from the PCD element, pH of an acid composition used to leach catalyst from the PCD element, leaching time used in a leaching process to leach catalyst from the PCD element, leaching temperature used to leach catalyst from the PCD element, leaching pressure used to leach catalyst from the PCD element, or combinations thereof.

16. A method of performing quality control on a polycrystalline diamond (“PCD”) element, the method comprising:
fabricating the PCD element in a high-pressure, high-temperature (“HPHT”) process;
at least partially leaching a catalyst from the PCD element to form an at least partially porous PCD element;
conducting porosimetry on the at least partially porous PCD element to measure at least one pore characteristic thereof; and
rejecting the at least partially porous PCD element if the at least one pore characteristic exceeds an acceptable range, or accepting the at least partially porous PCD element if the at least one pore characteristic is less than the acceptable range.

17. The method of claim 16 wherein conducting porosimetry on the at least partially porous PCD element to measure at least one pore characteristic of the plurality of pores of the at least partially porous PCD element includes conducting mercury porosimetry or helium porosimetry on the at least partially porous PCD element.

18. The method of claim 16 wherein the at least one pore characteristic includes at least one of average pore size, median pore size, pore size distribution, total pore volume, average pore throat diameter, median pore throat diameter, total pore area, or porosity.

19. The method of claim 16, further comprising determining an extent of diamond-to-diamond bonding within the PCD element at least partially based on the measured at least one pore characteristic.

20. The method of claim 16 wherein the at least partially porous PCD element is at least partially leached and attached to a substrate.

21. The method of claim 16 wherein the at least partially porous PCD element includes an at least partially leached PCD disk.

22. A method of performing quality control on a polycrystalline diamond (“PCD”) element, the method comprising:
fabricating the PCD element in a high-pressure, high-temperature (“HPHT”) process;
at least partially leaching a catalyst from the PCD element to form an at least partially porous PCD element;
conducting porosimetry on the at least partially porous PCD element to measure at least one pore characteristic thereof; and
grouping the at least partially porous PCD element with other PCD elements if the at least one pore characteristic is within an acceptable range.

23. The method of claim 21 wherein the at least one pore characteristic includes at least one of average pore size, median pore size, pore size distribution, total pore volume, average pore throat diameter, median pore throat diameter, total pore area, or porosity.

24. The method of claim 21, further comprising determining an extent of diamond-to-diamond bonding within the PCD element at least partially based on the measured at least one pore characteristic.
